(19) United States
(12) Patent Application Publication
(10) Pub. No.: US 2021/0176174 A1
(43) Pub. Date: Jun. 10, 2021

(54) LOAD BALANCING DEVICE AND METHOD FOR AN EDGE COMPUTING NETWORK

(71) Applicant: Institute For Information Industry, Taipei (TW)

(72) Inventors: Jerry CHOU, Taipei (TW); Chih-Hsiang HO, Taipei (TW)

(21) Appl. No.: 16/708,106

(22) Filed: Dec. 9, 2019

(30) Foreign Application Priority Data
Dec. 5, 2019 (TW) 108144534

(51) Int. Cl. H04L 12/803

(52) U.S. Cl. CPC H04L 47/125

(57) ABSTRACT

A load balancing device and method for an edge computing network are provided. The device performs the following operations: (a) calculating a computing time of each edge device and an average computing time of them, (b) determining a first edge device from the edge devices, wherein the computing time of the first edge device is greater than the average computing time, (c) determining a second edge device from the edge devices, wherein the computing time of the second edge device is less than the average computing time, and the current stored data amount of the second edge device is lower than the maximum stored capacity of the second edge device, (d) instructing the first edge device to move a portion of the training dataset to the second edge device, and (e) updating the current stored data amount of each of the first edge device and the second edge device.

This application claims priority to Taiwan Patent Application No. 108144534 filed on Dec. 5, 2019, which is hereby incorporated by reference in its entirety.

### CROSS-REFERENCES TO RELATED APPLICATIONS

Not applicable.

### BACKGROUND OF THE INVENTION

### Field of the Invention

The present invention relates to a load balancing device and method. More specifically, the present invention relates to a load balancing device and method for an edge computing network.

### Descriptions of the Related Art

With the rapid development of deep learning technology, various trained deep learning models have been widely used in different fields. For example, image processing devices (e.g. cameras in an automatic store) have used object detection models created by deep learning technology to detect objects in images or image sequences, and thus accurately determine the products that customers take.

No matter which deep learning model is used, the deep learning model needs to be trained with a large number of datasets before the deep learning model is used as a practice. At present, most of deep learning models are trained by using cloud systems and a centralized architecture. However, the use of cloud systems and the centralized architecture have the following disadvantages: (1) since most of the training datasets of deep learning models include trade secrets, personal information, etc., there are some risk of privacy leaks when all training datasets are sent to the cloud system, (2) there will be a time delay in uploading training datasets to the cloud system, and the performance will be affected by the network transmission bandwidth, (3) since the training of deep learning model is performed by the cloud system, the edge computing resources (e.g. edge nodes with computing capability) are idle and the edge computing resources cannot be effectively used, resulting in a waste of computing resources, and (4) training a deep learning model requires a large amount of data transmission and calculation, which increases the cost of using cloud systems.

Therefore, in recent years, there have been some techniques to apply edge computing to training deep learning models. Specifically, edge computing is a decentralized computing architecture that moves the calculation of data from the network center node to the edge nodes for processing. Edge computing decomposes the large-scale services that were originally handled by the network central node, and segments the large-scale services into smaller and more manageable parts to be distributed to the edge nodes for processing. Compared with the cloud system, the edge node is closer to the terminal device, so the data processing and transmission speed can be accelerated, and thus the delay can be reduced. Under the architecture of edge computing, the analysis of training datasets and the generation of knowledge are closer to the source of the data and thus the edge computing is more suitable for processing big data.

However, there are still some problems to be solved when using edge computing and decentralized architecture to train deep learning models. Specifically, the hardware specifications of each edge device under the edge computing network are different, which makes each edge device have different computing capabilities and storage space. Therefore, when each edge device acts as a “worker”, the computing time required by each edge device is not the same. Furthermore, under Data Parallelism computing architecture, the training of the deep learning model will be subject to edge devices with low processing efficiency, resulting in a delay in the overall training time of the deep learning model.

Accordingly, there is an urgent need for a technique that can provide a load balancing technology for an edge computing network to reduce the training time of deep learning models.

### SUMMARY OF THE INVENTION

An objective of the present invention is to provide a load balancing device for an edge computing network. The edge computing network includes a plurality of edge devices, each of the edge devices stores a training dataset. The load balancing device comprises a storage and a processor, and the processor is electrically connected to the storage. The storage stores a piece of performance information, wherein the performance information comprises a computing capability, a current stored data amount, and a maximum stored capacity of each edge device. The processor performs the following operations: (a) calculating a computing time of each edge device and an average computing time of the edge devices; (b) determining a first edge device from the edge devices, wherein the computing time of the first edge device is greater than the average computing time; (c) determining a second edge device from the edge devices, wherein the computing time of the second edge device is less than the average computing time, and the current stored data amount of the second edge device is lower than the maximum stored capacity of the second edge device; (d) instructing the first edge device to move a portion of the training dataset to the second edge device according to an amount of moving data, and (e) updating the current stored data amount of each of the first edge device and the second edge device.

Another objective of the present invention is to provide a load balancing method for an edge computing network, which is adapted for use in an electronic apparatus. The edge computing network includes a plurality of edge devices, each of the edge devices stores a training dataset. The electronic apparatus stores a piece of performance information, and the performance information comprises a computing capability, a current stored data amount, and a maximum stored capacity of each edge device. The load balancing method comprises the following steps: (a) calculating a computing time of each edge device and an average computing time of the edge devices; (b) determining a first edge device from the edge devices, wherein the computing time of the first edge device is greater than the average computing time; (c) determining a second edge device from the edge devices, wherein the computing time of the second edge device is less than the average computing time, and the current stored data amount of the second edge device is lower than the maximum stored capacity of the second edge device; (d) instructing the first edge device to move a portion of the training dataset to the second edge device according to an amount of moving data, and (e) updating the current stored data amount of each of the first edge device and the second edge device.

According to the above descriptions, the load balancing technology (including the apparatus and the method) for an edge computing network provided by the present invention calculates a computing time of each edge device and an average computing time of the edge devices based on the performance information (i.e., a computing capability, a current stored data amount, and a maximum stored capacity of each edge device), determines one of the edge devices (i.e., the first edge device) that needs to move a portion of the training dataset, and determines one of the edge devices (i.e., the second edge device) that has to receive the moved training dataset. The load balancing technology then instructs the first edge device to move the portion of the training dataset to the second edge device according to the amount of moving data, and then update the performance information.

The load balancing technology provided by the present invention can also recalculate the computing time of each edge device. When the recalculated computing time still does not reach an evaluation condition (e.g., when the computing times are not all less than a preset value), the load balancing technology provided by the present invention will repeatedly perform the foregoing operations. Therefore, the load balancing technology provided by the present invention effectively reduces the time for training the deep learning model under the edge computing network architecture, and solves the problem in the prior art that wasting technical computing resources.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 illustrates a schematic view of an application environment of the first embodiment;

FIG. 2 illustrates a schematic view of the load balancing device 2 of the first embodiment;

FIG. 3A illustrates a specific example of the performance information of the first embodiment;

FIG. 3B illustrates a specific example of the calculation result of the first embodiment;

FIG. 4 illustrates a partial flowchart of the load balancing method of the second embodiment;

FIG. 5 illustrates a partial flowchart of the method performed by some embodiments; and

FIG. 6 illustrates a partial flowchart of the method performed by some embodiments.

### DESCRIPTION OF THE PREFERRED EMBODIMENT

In the following description, a load balancing device and method for an edge computing network according to the present invention will be explained with reference to embodiments thereof. However, these embodiments are not intended to limit the present invention to any environment, applications, or implementations described in these embodiments. Therefore, description of these embodiments is only for purpose of illustration rather than to limit the present invention. It shall be appreciated that, in the following embodiments and the attached drawings, elements unrelated to the present invention are omitted from depiction. In addition, dimensions of individual elements and dimensional relationships among individual elements in the attached drawings are provided only for illustration but not to limit the scope of the present invention.

First, the applicable target and advantages of the present invention are briefly explained. Generally speaking, under the network structure of cloud and fog deployment, devices are hierarchical classified by computing capabilities and storage capacities (i.e., the closer the device to the cloud end has the stronger computing capability and the storage capacity; on the contrary, the closer the device to the fog end has the simpler the computing capability and the storage capacity). The invention mainly focuses on training the deep learning model by the edge device on the fog end, and provides the load balancing technology to reduce the overall training time of the deep learning model. Therefore, the present invention can provide the following advantages: (1) the training dataset is retained on the edge devices, thereby ensuring that data privacy is not leaked, (2) the remaining computing resources of the edge devices are being utilized, and thus the calculation cost can be reduced, (3) the cost of moving the training dataset to the cloud system can be reduced, and (4) the training time of the deep learning model can be reduced by using the decentralized architecture.

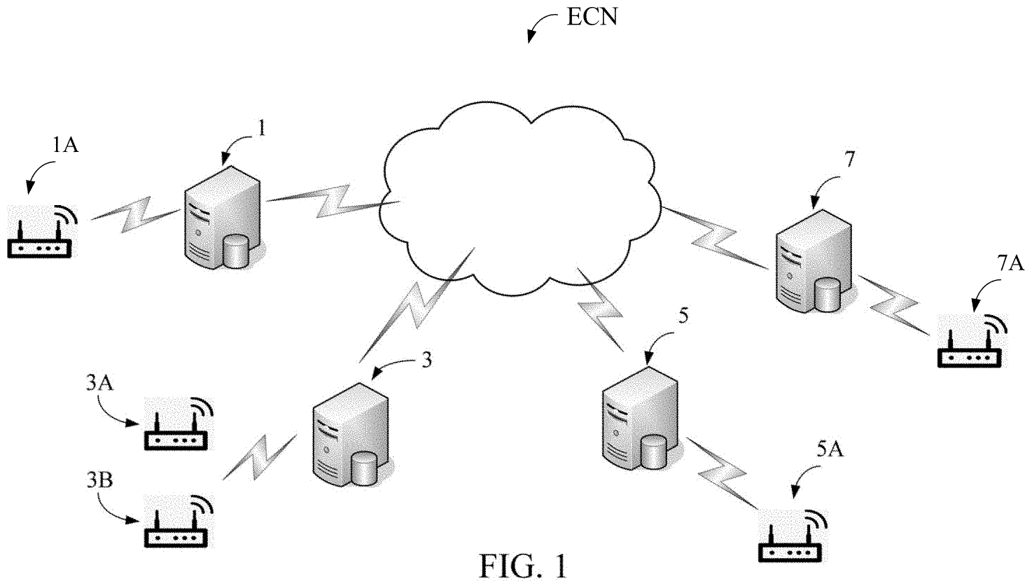

Please refer to FIG. 1, which is a schematic view of an application environment of the present invention. As shown in FIG. 1, the edge computing network ECN includes four edge devices 1, 3, 5, and 7, and the edge devices 1, 3, 5, and 7 can be connected to each other. The present invention does not limit the way in which the edge device 1, 3, 5, 7 are connected to each other. The edge devices 1, 3, 5, 7 can collect the training dataset from their corresponding sensing devices. Referring to an example as shown in FIG. 1, the edge device 1 receives the training dataset from the sensing device 1A, the edge device 3 receives the training dataset from the sensing device 3A and the sensing device 3B, the edge device 5 receives the training dataset from the sensing device SA, and the edge device 7 receives the training dataset from the sensing device 7A. In this embodiment, the edge devices 1, 3, 5, and 7 have stored the training dataset transmitted by the corresponding sensing devices 1A, 3A, 3B, 5A, and 7A, and the edge devices 1, 3, 5, and 7 are ready to perform further training of the deep learning model.

It should be noted that the edge device can be any device with basic computing capability and storage capacity, and the sensing device can be any Internet of Things (IoT) device (e.g., image capture device) that can generate training datasets. The present invention does not limit the number of edge devices that the edge computing network can include and the number of sensing devices that each edge device can cover, and it depends on the size of the edge computing network, the size of the edge devices, and the actual needs. It shall be appreciated that the training of deep learning models also includes other operations. Since the present invention focuses on the calculation and analysis related to the load balancing, only the implementation details related to the present invention will be detailed in the following paragraphs.

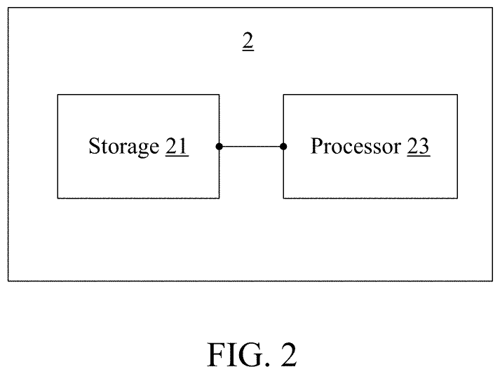

The first embodiment of the present invention is a load balancing device 2 for an edge computing network, and the schematic view of the load balancing device 2 is depicted in FIG. 2. It should be noted that the load balancing device 2 may be assumed by anyone of the edge devices 1, 3, 5, and 7 in FIG. 1. In some embodiment the load balancing device 2 may also be assumed by another edge device that is in the higher layer of the edge computing network (e.g., the edge device which is not connected to the sensing device). The load balancing device 2 is used to load balancing the training dataset to be used by these edge devices to reduce the training time of the deep learning model. Therefore, in some embodiments, the load balancing device 2 may be assumed by the edge device with the strongest computing capability in the edge computing network. In some embodiments, the load balancing device 2 may also be an external device connected to the edge computing network and having control authority, the present invention does not limit its content.

In this embodiment, the load balancing device 2 comprises a storage 21 and a processor 23, and the processor 23 is electrically connected to the storage 21. The storage 21 may be a memory, a Universal Serial Bus (USB) disk, a hard disk, a Compact Disk (CD), a mobile disk, or any other storage medium or circuit known to those of ordinary skill in the art and having the same functionality. The processor 23 may be any of various processors, Central Processing Units (CPUs), microprocessors, digital signal processors or other computing apparatuses known to those of ordinary skill in the art.

First, the operation concept of the present invention will be briefly explained. Because different edge devices have different hardware specifications, each edge device requires different computing time to train a deep learning model based on the training dataset it collects. However, under the framework of parallel processing, if the computing time of an edge device significantly exceeds the computing time of other edge devices, the overall training time of the deep learning model will be delayed. Therefore, under a parallel processing architecture, the load balancing device 2 will analyze the edge devices in the edge computing network to instruct a certain edge device to move a portion of its training dataset to balance the computing time of the edge devices, and thus reducing the overall training time of the deep learning model.

Specifically, the reduction of the overall training time T of the deep learning model can be expressed by the following formula (1):

MIN(T)=MIN(α×Tₜᵣₐₙₛ+β×T_{comp}+γ×T_{comm}) (1)

In the above formula (1), the variable α, the variable β and the variable γ are positive integers, the parameter Tₜᵣₐₙₛ is the data transmission time, the parameter T_{comp} is the computing time, and the parameter T_{comm} is the communication time required for the load balancing device 2 to cooperate with the edge device.

In addition, the parameter Tₜᵣₐₙₛ representing the data transmission time can be expressed by the following formula (2):

$${T}_{trans} = {\sum }_{∀ i , j} \frac{M [ i , j ]}{{B}_{i , j}} \qquad ( 2 )$$

In the above formula (2), M[i, j] representing the amount that the training dataset is moved from the iₜₕ edge device to the jₜₕ edge device, and Bᵢⱼ is the transmission bandwidth between the iₜₕ edge device and the jₜₕ edge device.

In addition, the parameter T_{comp} representing the computing time can be expressed by the following formula (3):

$${T}_{comp} = {MAX}_{∀ i} ( \frac{( {D}_{i} - {Σ}_{∀ j} M [ i , j ] + {Σ}_{∀ j} M [ j , i ] )}{{C}_{i}} ) \qquad ( 3 )$$

In the above formula (3), Dᵢ is the current stored data amount of the iₜₕ edge device, and M[i, j] representing the amount that the training dataset is moved from the iₜₕ edge device to the jₜₕ edge device, M[j, i] representing the amount that the training dataset is moved from the jₜₕ edge device to the iₜₕ edge device, and Cᵢ is the computing capability of the iₜₕ edge device.

It should be noted that the present invention is aiming to reduce the overall training time of a deep learning model, and in a general case, the computing time (i.e., the parameter T_{comp} in the above formula) is the most critical parameter. Specifically, since in the training process of deep learning models, the computing time is often much higher than the data transmission time (i.e., the parameter Tₜᵣₐₙₛ in the above formula) and communication time (i.e., the parameter T_{comm} in the above formula, usually is a fixed value). Therefore, if the computing time can be effectively reduced, the overall training time of the deep learning model can be greatly improved. Hence, reducing the computing time is the main goal of the present invention. Since the computing capabilities of different edge devices are inconsistent, the average computing time can be effectively reduced by adjusting the amount of training dataset that the edge device with poor computing capabilities needs to compute. The present invention provides a load balancing mechanism based on the aforementioned formula, and the following paragraphs will detail the implementation details related to the present invention.

In this embodiment, the storage 21 of the load balancing device 2 stores the relevant information of each edge device in the edge computing network in advance, and updates it in real time after each load balancing operation is completed. Therefore, the load balancing device 2 can analyze the pre-stored relevant information to find the edge device that causes the overall computing delay (i.e., increase the average computing time) in the edge computing network, and then the load balancing device 2 executes the load balance operation to the edge device. Specifically, the storage 21 of the load balancing device 2 stores a piece of performance information, and the performance information comprises a computing capability, a current stored data amount (i.e., the training dataset stored in the edge device), and a maximum stored capacity of each edge device.

It should be noted that the performance information stored in the storage 21 may be acquired by different ways, for example, the load balancing device 2 actively requests from each edge device, or inputs after being integrated by other external devices, the present invention does not limit the ways to acquire the performance information. It shall be appreciated that the computing capability of the edge device may be the ability to train a deep learning model with a training dataset. Since each piece of data in the training dataset has a similar format, the load balancing device 2 can quantify the computing capability of each edge device through a unified standard, for example, the amount of data that the edge device can process per second.

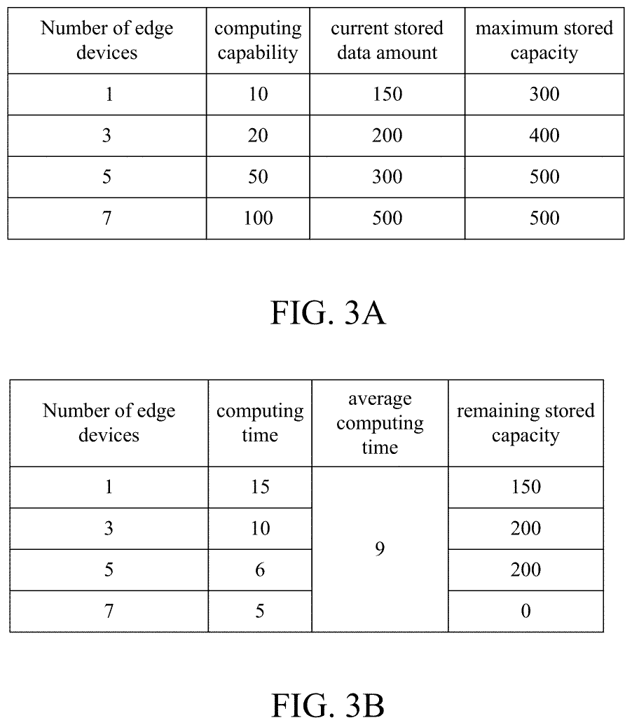

FIG. 3A illustrates a specific example of the performance information stored in the storage 21, and the specific example is not intended to limit the scope of the present invention. As shown in FIG. 3A, the computing capability of the edge device 1 is 10 (pieces/per second), the current stored data amount is 150 (i.e., the training data set has 150 pieces of data), and the maximum stored capacity is 300. The computing capability of the edge device 3 is 20 (pieces/per second), the current stored data amount is 200, and the maximum stored capacity is 400. The computing capability of the edge device 5 is 50 (pieces/per second), the current stored data amount is 300, and the maximum stored capacity is 500. The computing capability of the edge device 7 is 100 (pieces/per second), the current stored data amount is 500, and the maximum stored capacity is 500.

In this embodiment, the processor 23 first calculates a computing time of each edge device and an average computing time of the edge devices. Specifically, the processor 23 first calculates the computing time of each edge device according to the computing capability and the current stored data amount of each edge device, and then the processor 23 calculates the average computing time of the edge devices according to the computing times. For example, the computing capability of the edge device 1 is 10 (pieces/per second) and the currently stored data amount is 150, so the computing time of the edge device 1 is 15 seconds.

Thereafter, since the processor 23 has calculated the computing time of each edge device and the average computing time, the processor 23 selects an edge device with a longer computing time from these edge devices to move the training dataset to reduce the computing time of the edge device, and thus the purpose of reducing the overall training time of the deep learning model can be achieved. Specifically, the processor 23 determines a first edge device from the edge devices, and the computing time of the first edge device is greater than the average computing time. In some embodiments, the processor 23 selects the one with the largest computing time from the edge devices as the first edge device.

Next, the processor 23 selects an edge device from the edge devices whose computing time is lower than the average computing time and still has storage space to receive training data, so as to perform the subsequent transferring of training data. Specifically, the processor 23 determines a second edge device from the edge devices, the computing time of the second edge device is less than the average computing time, and the current stored data amount of the second edge device is lower than the maximum stored capacity of the second edge device.

In some embodiments, in order to reduce the transmission time during the move of training dataset (i.e., the parameter Tₜᵣₐₙₛ in the above formula), the performance information stored in the storage 21 further comprises a transmission bandwidth of each edge device. In these embodiments, when the processor 23 determines the second edge node device (i.e., the edge device that receives the moved training data), the processor 23 selects the one with the largest transmission bandwidth from the edge devices as the second edge device, so that the transmission time can be reduced (i.e., the transmission time of the first edge device moving training data to the second edge device).

In this embodiment, the processor 23 has determined the edge devices (i.e., the first edge device) that needs to move a portion of the training dataset and the edge devices (i.e., the second edge device) that has to receive the moved training dataset. Next, the processor 23 instructs the first edge device to move a portion of the training dataset to the second edge device according to an amount of moving data. It shall be appreciated that the amount of moving data is calculated by the processor 23, the processor 23 determines the need and the reasonable amount of moving data of the first edge device, and the amount of moving data have to be within the allowed range of the second edge device (i.e., the second edge device still has the storage space to receive the moved data).

For example, the processor 23 calculates an estimated amount of moving data based on a difference between the computing time of the first edge device and the average computing time and a computing capability of the first edge device. Next, the processor 23 calculates the amount of moving data based on the estimated amount of moving data, the current stored data amount and the maximum stored capacity of the second edge device.

It shall be appreciated that since the amount of moving data calculated by the processor 23 has to be reasonable and achievable, in addition to determining the amount of training data that the first edge device has to move, it is also necessary to determine whether the space of the second edge device is acceptable. Therefore, in some embodiments, the processor 23 calculates a remaining stored capacity of the second edge device based on the current stored data amount and the maximum stored capacity of the second edge device, and then selects the one with the smaller value as the amount of moving data from the remaining stored capacity and the estimated amount of moving data.

Finally, the processor 23 updates the current stored data amount of the first edge device and the current stored data amount of the second edge device in the performance information, so that the performance information can reflect the current condition of the edge devices in real time.

For comprehension, please refer to a specific example shown in FIG. 3A and FIG. 3B. First, the processor 23 divides the current stored data amount of each edge device (i.e., edge devices 1, 3, 5, and 7) by the computing capability of each edge device to calculate the computing time of each edge device. In this specific example, the computing time of the edge devices 1, 3, 5, and 7 are 15, 10, 6, and 5 (seconds), respectively. Next, the processor 23 calculates the average computing time of edge devices 1, 3, 5, 7 is 9 (seconds). Next, the processor 23 selects the edge device 1 which has the largest computing time as the edge device that has to move the portion of the training dataset (i.e., the aforementioned first edge device). Subsequently, the processor 23 determines the edge device that has to receive the moved training dataset (i.e., the aforementioned second edge device). In this specific example, the processor 23 determines that both the computing times of the edge devices 5 and 7 are shorter than the average computing time of 9 (second), and further determines that only the current stored data amount of the edge device 5 has a lower than the maximum stored capacity of the edge device 5 (i.e., the remaining stored capacity is greater than 0). Therefore, the processor 23 determines the edge device 5 as the edge device that has to receive the moved training dataset.

Then, based on the previous calculation result, the processor 23 calculates a difference between the computing time of the edge device 1 and the average computing time, and the difference is 6 (second) in this specific example (i.e., the computing time of the edge device 1 is 15 and the average computing time is 9). Next, the processor 23 calculates the amount of moving data that needs to be moved from the edge device 1 to make the computing time of the edge device 1 close to the average computing time. Specifically, the processor 23 calculates the estimated amount of moving data by multiplying the time difference of 6 (second) by the computing capability 10 (pieces/per second) of the edge device 1, and thus the estimated amount of moving data of the edge device 1 is 60 (pieces). Based on the result, the remaining stored capacity of the edge device 5 is 200 (pieces) of data and the estimated amount of moving data is 60, and the processor 23 selects the smaller one (i.e., the estimated amount of moving data 60) as the amount of moving data. Therefore, the processor 23 instructs the edge device 1 to move 60 pieces of training data in its training dataset to the edge device 5. Finally, after the load balancing operation is completed, the processor 23 updates the performance information stored in the storage 21 by the currently stored data amount of the edge device 1 (i.e., 90 pieces) and the currently stored data amount of the edge device 5 (i.e., 360 pieces).

In some embodiments, the processor 23 may perform the load balancing operations multiple times until the computing time of each edge device is less than a preset value. Specifically, after performing the first round of load balancing operation, the processor 23 recalculates the computing time of each edge device. Next, if the processor 23 determines that the computing times are not all less than a preset value, the processor 23 repeatedly performs the aforementioned operation until the computing times are all less than a preset value. In some implementations, the processor 23 may also perform the load balancing operations multiple times until the difference of the computing time between each pair of the edge devices is less than another preset value, for example, the difference of the computing time between each pair of the edge devices is less than 5 percentages or one standard deviation, etc.

According to the above descriptions, the load balancing device 2 calculates a computing time of each edge device and an average computing time of the edge devices based on the performance information (i.e., a computing capability, a current stored data amount, and a maximum stored capacity of each edge device), determines one of the edge devices (i.e., the first edge device) that needs to move a portion of the training dataset, and determines one of the edge devices (i.e., the second edge device) that has to receive the moved training dataset. The load balancing device 2 then instructs the first edge device to move the portion of the training dataset to the second edge device according to the amount of moving data, and then update the performance information. The load balancing device 2 can also recalculate the computing time of each edge device. When the recalculated computing time still does not reach an evaluation condition (e.g., when the computing times are not all less than a preset value), the load balancing device 2 will repeatedly perform the foregoing operations. Therefore, the load balancing device 2 effectively reduces the time for training the deep learning model under the edge computing network architecture, and solves the problem in the prior art that wasting technical computing resources.

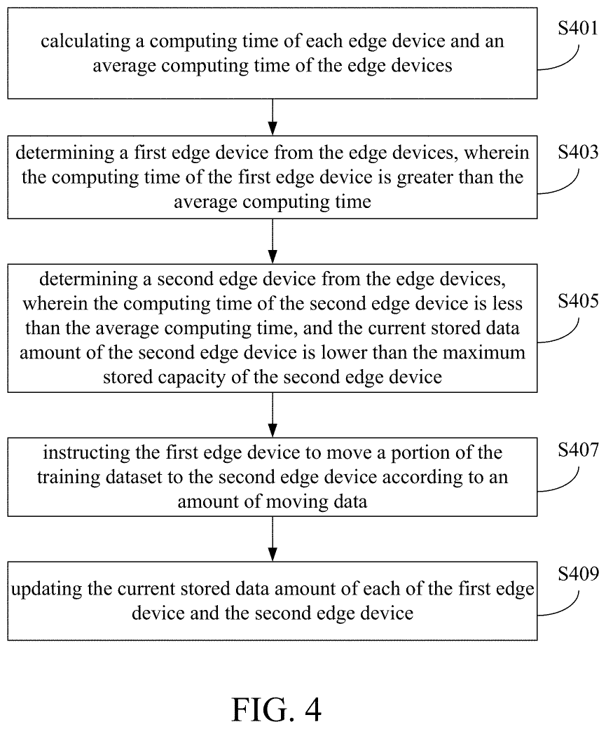

A second embodiment of the present invention is a load balancing method for an edge computing network and a flowchart thereof is depicted in FIG. 4. The load balancing method is adapted for an electronic apparatus (e.g., the load balancing device 2 of the first embodiment). The edge computing network includes a plurality of edge devices, each of the edge devices stores a training dataset. The electronic apparatus stores a piece of performance information, the performance information comprises a computing capability, a current stored data amount, and a maximum stored capacity of each edge device. The load balancing method performs the load balancing through the steps S401 to S409.

In step S401, the electronic apparatus calculates a computing time of each edge device and an average computing time of the edge devices. Next, in step S403, the electronic apparatus determines a first edge device from the edge devices, wherein the computing time of the first edge device is greater than the average computing time.

Thereafter, in step S405, the electronic apparatus determines a second edge device from the edge devices, wherein the computing time of the second edge device is less than the average computing time, and the current stored data amount of the second edge device is lower than the maximum stored capacity of the second edge device. Next, in step S407, the electronic apparatus instructs the first edge device to move a portion of the training dataset to the second edge device according to an amount of moving data. Finally, in step S409, the electronic apparatus updates the current stored data amount of each of the first edge device and the second edge device.

In some embodiments, wherein step S401 comprises the following steps: calculating the computing time of each edge device according to the computing capability and the current stored data amount of each edge device; and calculating the average computing time of the edge devices according to the computing times. In some embodiments, wherein step S403 comprises the following step: selecting the one with the largest computing time from the edge devices as the first edge device.

In some embodiments, wherein the performance information further comprises a transmission bandwidth of each edge device. In this embodiment, step S405 comprises the following step: selecting the one with the largest transmission bandwidth from the edge devices as the second edge device.

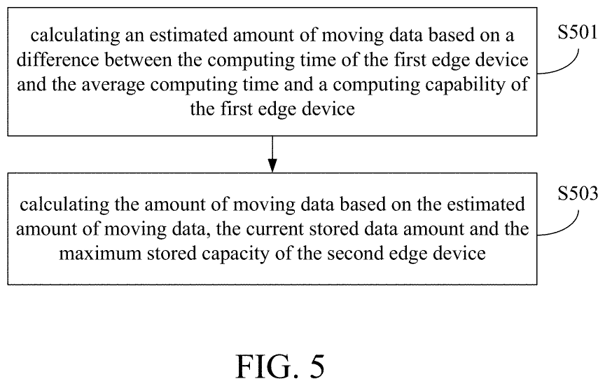

In some embodiments, step S407 further comprises steps S501 to S503 shown in FIG. 5. In step S501, the electronic apparatus calculates an estimated amount of moving data based on a difference between the computing time of the first edge device and the average computing time and a computing capability of the first edge device. Next, in step S503, the electronic apparatus calculates the amount of moving data based on the estimated amount of moving data, the current stored data amount and the maximum stored capacity of the second edge device. In some embodiments, wherein step S503 further comprises the following steps: calculating a remaining stored capacity of the second edge device based on the current stored data amount and the maximum stored capacity of the second edge device; and selecting the one with the smaller value as the amount of moving data from the remaining stored capacity and the estimated amount of moving data.

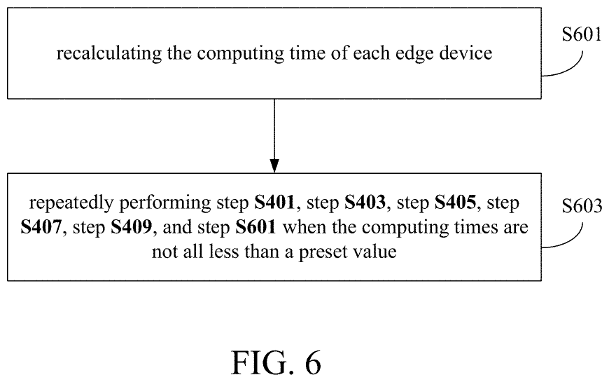

In some embodiments, the load balancing method further comprises steps S601 to S603 shown in FIG. 6. In step S601, the electronic apparatus recalculates the computing time of each edge device. Next, in step S601, the electronic apparatus repeatedly performs step S401, step S403, step S405, step S407, step S409, and step S601 when the computing times are not all less than a preset value.

In addition to the aforesaid steps, the second embodiment can also execute all the operations and steps of the load balancing device 2 set forth in the first embodiment, have the same functions, and deliver the same technical effects as the first embodiment. How the second embodiment executes these operations and steps, has the same functions, and delivers the same technical effects will be readily appreciated by those of ordinary skill in the art based on the explanation of the first embodiment. Therefore, the details will not be repeated herein.

It shall be appreciated that in the specification and the claims of the present invention, some words (e.g., edge device) are preceded by terms such as “first” or “second,” and these terms of “first” and “second” are only used to distinguish these different terms. For example, the “first” and “second” in the first edge device and the second edge device are only used to indicate different edge devices.

According to the above descriptions, the load balancing technology (including the apparatus and the method) for an edge computing network provided by the present invention calculates a computing time of each edge device and an average computing time of the edge devices based on the performance information (i.e., a computing capability, a current stored data amount, and a maximum stored capacity of each edge device), determines one of the edge devices (i.e., the first edge device) that needs to move a portion of the training dataset, and determines one of the edge devices (i.e., the second edge device) that has to receive the moved training dataset. The load balancing technology then instructs the first edge device to move the portion of the training dataset to the second edge device according to the amount of moving data, and then update the performance information.

The load balancing technology provided by the present invention can also recalculate the computing time of each edge device. When the recalculated computing time still does not reach an evaluation condition (e.g., when the computing times are not all less than a preset value), the load balancing technology provided by the present invention will repeatedly perform the foregoing operations. Therefore, the load balancing technology provided by the present invention effectively reduces the time for training the deep learning model under the edge computing network architecture, and solves the problem in the prior art that wasting technical computing resources.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A load balancing device for an edge computing network, the edge computing network including a plurality of edge devices, each of the edge devices storing a training dataset, the load balancing device comprising:
a storage, storing a piece of performance information, wherein the performance information comprises a computing capability, a current stored data amount, and a maximum stored capacity of each edge device; and
a processor, being electrically connected to the storage, and being configured to perform the following operations:
(a) calculating a computing time of each edge device and an average computing time of the edge devices;
(b) determining a first edge device from the edge devices, wherein the computing time of the first edge device is greater than the average computing time;
(c) determining a second edge device from the edge devices, wherein the computing time of the second edge device is less than the average computing time, and the current stored data amount of the second edge device is lower than the maximum stored capacity of the second edge device;
(d) instructing the first edge device to move a portion of the training dataset to the second edge device according to an amount of moving data, and
(e) updating the current stored data amount of each of the first edge device and the second edge device.

2. The load balancing device of claim 1, wherein the operation (a) comprises the following operations:
calculating the computing time of each edge device according to the computing capability and the current stored data amount of each edge device; and
calculating the average computing time of the edge devices according to the computing times.

3. The load balancing device of claim 1, wherein in the operation (b), the processor selects the one with the largest computing time from the edge devices as the first edge device.

4. The load balancing device of claim 1, wherein the performance information further comprises a transmission bandwidth of each edge device, and the processor selects the one with the largest transmission bandwidth from the edge devices as the second edge device in the operation (c).

5. The load balancing device of claim 1, wherein in operation (d), the amount of moving data is determined by the following operations:
(d1) calculating an estimated amount of moving data based on a difference between the computing time of the first edge device and the average computing time and a computing capability of the first edge device; and
(d2) calculate the amount of moving data based on the estimated amount of moving data, the current stored data amount and the maximum stored capacity of the second edge device.

6. The load balancing device of claim 5, wherein the operation (d2) further comprises the following steps:
calculating a remaining stored capacity of the second edge device based on the current stored data amount and the maximum stored capacity of the second edge device; and
selecting the one with the smaller value as the amount of moving data from the remaining stored capacity and the estimated amount of moving data.

7. The load balancing device of claim 1, wherein the processor further performs the following operations:
(f) recalculating the computing time of each edge device; and
(g) repeatedly performing the operation (a), the operation (b), the operation (c), the operation (d), the operation (e), and the operation (f) when the computing times are not all less than a preset value.

8. A load balancing method for an edge computing network, the load balancing method being adapted for use in an electronic apparatus, the edge computing network including a plurality of edge devices, each of the edge devices storing a training dataset, the electronic apparatus storing a piece of performance information, the performance information comprising a computing capability, a current stored data amount, and a maximum stored capacity of each edge device, the load balancing method comprising the following steps:
(a) calculating a computing time of each edge device and an average computing time of the edge devices;
(b) determining a first edge device from the edge devices, wherein the computing time of the first edge device is greater than the average computing time;
(c) determining a second edge device from the edge devices, wherein the computing time of the second edge device is less than the average computing time, and the current stored data amount of the second edge device is lower than the maximum stored capacity of the second edge device;
(d) instructing the first edge device to move a portion of the training dataset to the second edge device according to an amount of moving data, and
(e) updating the current stored data amount of each of the first edge device and the second edge device.

9. The load balancing method of claim 8, wherein the step (a) comprises the following steps:
calculating the computing time of each edge device according to the computing capability and the current stored data amount of each edge device; and
calculating the average computing time of the edge devices according to the computing times.

10. The load balancing method of claim 8, wherein the step (b) comprises the following step:
selecting the one with the largest computing time from the edge devices as the first edge device.

11. The load balancing method of claim 8, wherein the performance information further comprises a transmission bandwidth of each edge device, and the step (c) comprises the following step:
selecting the one with the largest transmission bandwidth from the edge devices as the second edge device.

12. The load balancing method of claim 8, wherein in step (d), the amount of moving data is determined by the following steps:
(d1) calculating an estimated amount of moving data based on a difference between the computing time of the first edge device and the average computing time and a computing capability of the first edge device; and
(d2) calculate the amount of moving data based on the estimated amount of moving data, the current stored data amount and the maximum stored capacity of the second edge device.

13. The load balancing method of claim 12, wherein the step (d2) further comprises the following steps:
calculating a remaining stored capacity of the second edge device based on the current stored data amount and the maximum stored capacity of the second edge device; and
selecting the one with the smaller value as the amount of moving data from the remaining stored capacity and the estimated amount of moving data.

14. The load balancing method of claim 8, wherein the load balancing method further comprises the following steps:
(f) recalculating the computing time of each edge device; and
(g) repeatedly performing the step (a), the step (b), the step (c), the step (d), the step (e), and the step (f) when the computing times are not all less than a preset value.
